(19) United States
(12) Patent Application Publication
(10) Pub. No.: US 2006/0158645 A1
(43) Pub. Date: Jul. 20, 2006

(54) Method for Raman computer tomography imaging spectroscopy

(75) Inventors: John S. Maier, Pittsburgh, PA (US); Patrick J. Treado, Pittsburgh, PA (US)

Correspondence Address: Daniel H. Golub, 1701 Market Street, Philadelphia, PA, 19103-2217, US

(73) Assignee: ChemImage Corporation, Pittsburgh, PA (US)

(21) Appl. No.: 11/336,588

(22) Filed: Jan. 20, 2006

Related U.S. Application Data
(60) Provisional application No. 60/645,127, filed on Jan. 20, 2005.

(51) Int. Cl. G01J 3/44; G01N 21/65

(52) U.S. Cl. 356/301

(57) ABSTRACT

A method for measuring spatial and spectral information from a sample using computed tomography imaging spectroscopy. An area of the sample is illuminated using an illumination source having substantially monochromatic light. Raman scattered light is directed from said illuminated area of said sample onto a two dimensional grating disperser. Light output, from the two dimensional grating disperser, is directed onto a detector that detects a dispersed image. The dispersed image from the detector is applied to a processing algorithm that generates a plurality of spatially accurate, wavelength resolved images of the sample.

This application claims the benefit of U.S. Patent Application No. 60/645,127 filed Jan. 20, 2005 entitled Raman CTIS System.

### FIELD OF THE INVENTION

The present invention provides for a method for measuring spatial and spectral information from a sample using Computed Tomography Imaging Raman Spectroscopy.

### BACKGROUND OF THE INVENTION

When light interacts with matter, a portion of the incident photons are scattered in all directions. A small fraction of the scattered radiation differs in frequency (wavelength) from the illuminating light. If the incident light is monochromatic (single wavelength) as it is when using a laser source or other sufficiently monochromatic light source, the scattered light which differs in frequency may be distinguished from the light scattered which has the same frequency as the incident light. Furthermore, frequencies of the scattered light are unique to the molecular or crystal species present. This phenomenon is known as the Raman effect.

In Raman spectroscopy, energy levels of molecules are probed by monitoring the frequency shifts present in scattered light. A typical experiment consists of a monochromatic source (usually a laser) that is directed at a sample. Several phenomena then occur including Raman scattering which is monitored using instrumentation such as a spectrometer and a charge-coupled device (CCD). Similar to an infrared spectrum, a Raman spectrum reveals the molecular composition of materials, including the specific functional groups present in organic and inorganic molecules and specific vibrations in crystals. Raman spectrum analysis is useful because each measurement of Raman scattered light from a sample carries characteristic ‘fingerprint’ information about the molecular makeup of the sample.

Raman chemical imaging is an extension of Raman spectroscopy. Raman chemical imaging combines Raman spectroscopy and digital imaging for the molecular-specific image contrast without the use of stains or dyes. Raman image contrast is derived from a material's intrinsic vibrational spectroscopic signature, which is highly sensitive to the composition and structure of the material and its local chemical environment. As a result, Raman imaging can be performed with little or no sample preparation and is widely applicable for materials research, failure analysis, process monitoring and clinical diagnostics. Imaging spectrometers include Fabry Perot angle rotated or cavity tuned liquid crystal (LC) dielectric filters, acousto-optic tunable filters, and other LC tunable filters (LCTF) such as Lyot Filters and variants of Lyot filters such as Solc filters and the most preferred filter, an Evan's split element liquid crystal or a tunable multi conjugant filter. Previous Raman spectroscopy and chemical imaging work has been limited to monitoring the spectral range of 800 cm⁻¹ to 1200 cm⁻¹. However, for biological organisms and organic molecules significant structural information is found in the fingerprint region and the carbon-hydrogen stretching region of 2800 cm⁻¹ to 3200 cm⁻¹. Furthermore, monitoring of dynamic changes in a sample, using chemical imaging, has also been limited in that significant time may elapse between the collection of an image at a first wavelength and collection of an image at a second wavelength.

Computed Tomography Imaging Spectroscopy (“CTIS”) is used as a spectral imaging method. However, it is believed that previous CTIS systems have not been developed or applied to detect Raman light. The present invention addresses these shortcomings in the prior art.

### SUMMARY OF THE INVENTION

The present invention provides for a method for measuring spatial and spectral information from a sample using computed tomography imaging spectroscopy. An area of the sample is illuminated using an illumination source having substantially monochromatic light. Raman scattered light is directed from said illuminated area of said sample onto a two dimensional grating disperser. Light output, from the two dimensional grating disperser, is directed onto a detector that detects a dispersed image. The dispersed image from the detector is applied to a processing algorithm that generates a plurality of spatially accurate, wavelength resolved images of the sample.

The present invention also provides for a method for measuring spatial and spectral information from a sample over a period of time using computer tomography imaging spectroscopy. During a first time period, an area of the sample is illuminated using an illumination source having substantially monochromatic light. Raman scattered light is directed from said illuminated area of said sample onto a two dimensional grating disperser. Light output, from the two dimensional grating disperser, is directed onto a detector that detects a dispersed image. The dispersed image from the detector is applied to a processing algorithm that generates a plurality of spatially accurate, wavelength resolved images representative of the sample at the first time. During a second time period, these steps are repeated a second time to generate a second plurality of spatially accurate, wavelength resolved images representative of the sample at the second time, the second time being later than the first time. One or more dynamic changes in the sample are detected between the first and second times by comparing the first plurality of spatially accurate, wavelength resolved images and the second plurality of spatially accurate, wavelength resolved images.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates a system used in connection with the present invention;

FIG. 2 illustrates the processing of a dispersed image to generate a plurality of spatially accurate, wavelength resolved images of the sample;

FIG. 3 is a flow chart illustrating a preferred embodiment of the present invention;

FIG. 4 illustrates simulated images and Raman spectra obtained using the system of the present invention; and

FIG. 5 illustrates simulated images and Raman spectra obtained using the system of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

FIG. 1 illustrates system 100 that may be used to carry out the method of the present invention. Sample 101 is positioned on substrate 105. Substrate 105 can be any conventional microscopic slide or other means for receiving and optionally securing sample 100. Light source 102 is positioned to provide incident light to sample 100. Light source 102 provides substantially monochromatic light. The source 102 of substantially monochromatic light is preferably a laser source, such as a diode pumped solid state laser (e.g., a Nd:YAG or Nd:YVO4 laser) or Ar ion laser capable of delivering monochromatic light at a wavelength of 532 nanometers. In another embodiment, the substantially monochromatic light source 102 may comprise a UV light source or light source with wavelengths from the UV through the Near Infrared range (280 nm-900 nm). The substantially monochromatic light must hit the sample either directed from the source through the use of mirrors, a fiber conduit, or directly from the output of the source. It must also uniformly illuminate the sample 101 covering the entirety of the sample.

With further reference to FIG. 1, optical lens 104 is positioned to receive scattered light. Optical lens 104 may be used for gathering and focusing received photon beams. This includes gathering and focusing both polarized and the un-polarized photons. In general, the sample size determines the choice of light gathering optical lens 104. For example, a microscope lens may be employed for analysis of the sub-micron to micrometer specimens. For larger samples, macro lenses can be used. Optical lens 104 may include a simple reduced resolution/aberration lens with a larger numerical aperture to thereby increase the system's optical throughput and efficiency. Optical lens 104 is positioned to direct scattered photons to a two dimensional grating disperser 106.

System 100 may also include laser rejection filter 105. In one embodiment, the filter 105 may be positioned prior to the two dimensional grating disperser 106 to filter out scattered illumination light and to optimize the performance of the system. In other words, rejection filter 105 enables spectrally filtering of the photons at the illuminating wavelength.

A two dimensional grating disperser 106 which includes a hologram grating 108 is used to further the principles of the disclosure. The hologram grating 108 is fabricated using E-beam fabricated lithography. Grating 108 may be fabricated to achieve spectral wavelength resolution in the visible, UV, infrared or near-infrared wavelength range. In a preferred embodiment, the grating 108 is fabricated to achieve spectral resolution over a Raman Shift value in a spectra range of 2800 cm⁻¹ to 3200 cm⁻¹ corresponding to the carbon-hydrogen stretching modes. In a second preferred embodiment, the grating 108 is fabricated to achieve spectral resolution over a Raman Shift value in the fingerprint region corresponding to a spectra range of 500 cm⁻¹ to 2000 cm⁻¹.

Optical lens 110 may be used to directing light output from the two dimensional grating disperser 106 onto a detector 112 that detects a dispersed image. Detector 112 may be a digital device such as a two-dimensional, image focal plane array (“FPA”). In one embodiment, detector 112 produces digital images of the entire view of the sample as processed by the two dimensional grating disperser 106. The two dimensional grating disperser 106 advantageously simultaneously produces spatial information at a plurality of wavelengths in the resulting image for the same time. The FPA is preferably comprised of arrays having 1000×1000 pixels to 4000×4000 pixels.

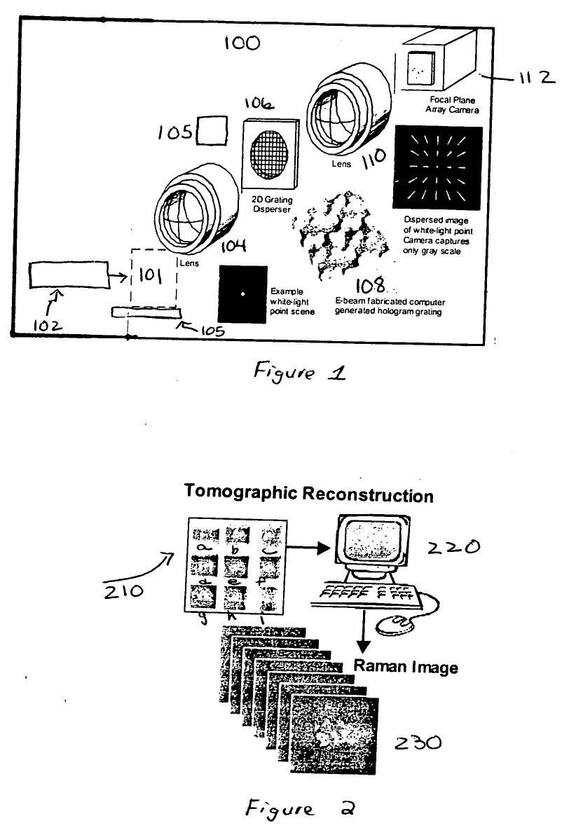

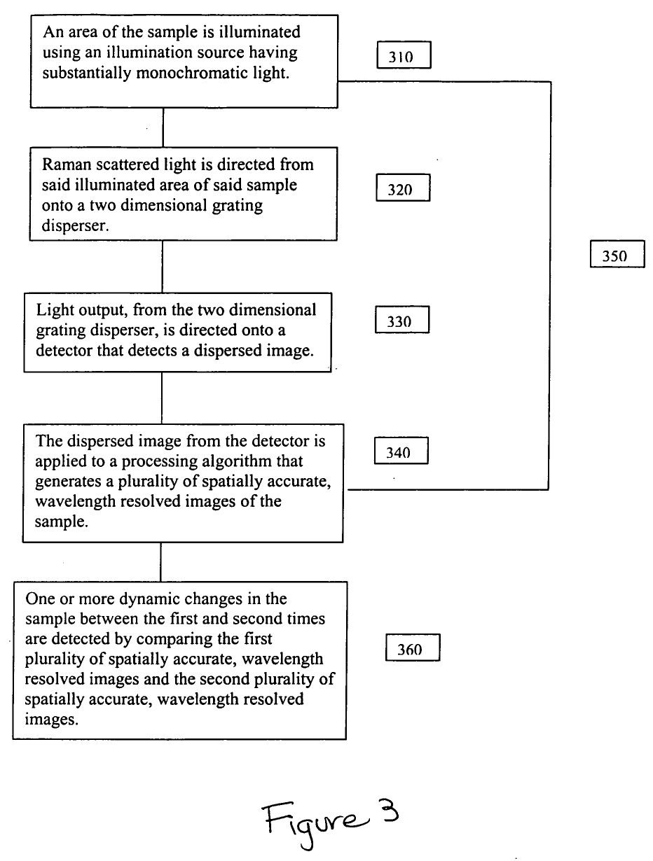

With reference to FIG. 2, the processing of the image and wavelength information is illustrated. Image matrix 210 (a)-(i) illustrates an image recorded on the detector 112 wherein each image (a)-(i) represents the area of the sample at various wavelengths of Raman scattered light after being dispersed by the two dimensional grating disperser 106. The images 210 (a)-(i) are then process by a computer 220 using a processing algorithm which generates a plurality of spatially accurate, wavelength resolved images 230 of the sample. In a preferred embodiment, a tomographic reconstruction algorithm is used.

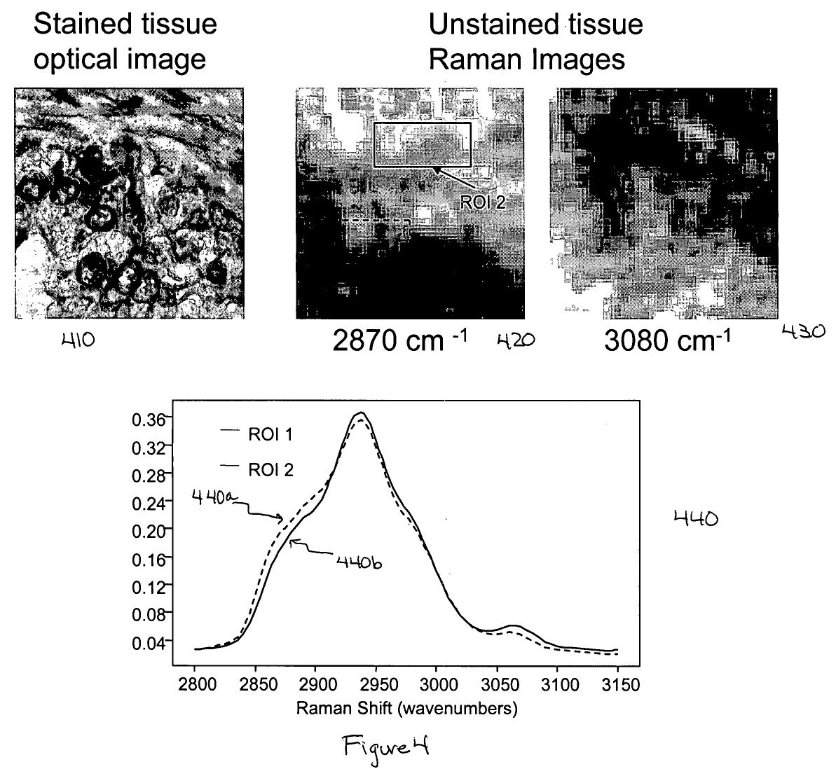

The present invention uses the system illustrated in FIG. 1 for measuring spatial and spectral information from a sample using Computed Tomography Imaging Raman Spectroscopy. With reference to FIG. 3, a flow chart is shown illustrating a method of the present invention. In step 310, an area of the sample 101 is illuminated using an illumination source having substantially monochromatic light. In step 320, Raman scattered light, from said illuminated area of the sample 101, is directed onto the two dimensional grating disperser 106. In step 330, light, output from the two dimensional grating disperser 106, is directed onto the detector 112 that detects a dispersed image. In step 340, the dispersed image from the detector 112 is applied to a processing algorithm that generates a plurality of spatially accurate, wavelength resolved images of the sample 101.

In various embodiments, the two dimensional grating disperser may be constructed to provide increased spectral resolution in a wavelength range of interest. In one embodiment, the light output from the two dimensional grating disperser comprises a Raman Shift value in a spectral range of 2800 cm⁻¹ to 3200 cm⁻¹ corresponding to C—H bond vibrations. In a second embodiment, the light output from the two dimensional grating disperser comprises a Raman Shift value in the fingerprint region of 500 cm⁻¹ to 2000 cm⁻¹. In another embodiment, the one or more of the spatially accurate, wavelength resolved images have a spectral resolution of less than or equal to 20 cm⁻¹.

The present invention also provides a method for detecting dynamic changes that occur in sample 101 between a first time interval and a second subsequent time interval. Approaches for dynamic chemical imaging are disclosed in: U.S. patent application Ser. No. 10/882,082, entitled System and Method for Dynamic Chemical Imaging, filed Jun. 30, 2004; and U.S. patent application Ser. No.______ , filed Nov. 8, 2005, entitled Dynamic Chemical Imaging of Biological Cells and Other Subjects each of which is incorporated herein by reference in their entirety.

As illustrated in FIG. 3, steps 310-340 are performed at a first time in order to generate a first plurality of spatially accurate, wavelength resolved images representative of the sample at the first time. In step 350, steps 310-340 are performed again at a second time in order to generate a second plurality of spatially accurate, wavelength resolved images representative of the sample at the second time, the second time being later than the first time. In step 360, one or more dynamic changes in the sample between the first and second times are detected by comparing the first plurality of spatially accurate, wavelength resolved images and the second plurality of spatially accurate, wavelength resolved images. Exemplary dynamic changes to apply Raman CTIS to include but are not limited to crystallization, chemical reaction monitoring as in a microfluidic system, changes in biological samples or systems including cells, tissues, or organisms or biological deposits of materials.

The present invention also provides for the application of system 1 to various applications including: the discrimination of cancer and cancer boundaries in tissue samples either in-vivo or in excised tissue from different tissues; the spatial discrimination of tissue characteristics such as tissue type such as epithelium, stroma, nerve, vessel etc.; for use with a fiberoptic visualization system for illuminating and collecting light from the sample; and the assessment of cellular samples either from patients, animals, or laboratory experiments. Approaches to spectroscopic imaging of different cell and tissue types are disclosed in: U.S. patent application Ser. No. 11/000,591 entitled Cytological Analysis by Raman Spectroscopic Imaging, filed Nov. 30, 2004; U.S. patent application Ser. No. 11/269,596 entitled, Cytological Methods for Detecting a Disease Condition Such as Malignancy by Raman Spectroscopic Imaging, filed Nov. 9, 2005; U.S. patent application Ser. No. 11/204,196, filed Aug. 9, 2005 entitled Method for Raman Chemical Imaging of Breast Tissue; U.S. patent application Ser. No. 11/097,161, filed Apr. 4, 2005, entitled Apparatus and Method for Chemical Imaging of a Biological Sample; U.S. patent application Ser. No. 11/000,545, filed Nov. 30, 2004 entitled Raman Molecular Imaging for Detection of Bladder Cancer; U.S. Pat. No. 6,965,793 entitled, Method for Raman Chemical Imaging of Endogenous Chemicals to Reveal Tissue Lesion Boundaries; and U.S. Pat. Nos. 6,954,667 and 6,965,793 entitled Method for Raman Chemical Imaging and Characterization of Calcification in Tissue each of which is incorporated herein in its entirety.

In one embodiment, the system described in FIG. 1 may be used to differentiate normal from cancerous cells in bladder tissue. Cancerous cells, found in bladder tissue, exhibit significant Raman scattering at a Raman shift (“RS”) value of about 1584 cm⁻¹. The intensity of Raman scattering at this RS values increases with increasing grade of bladder cancer. Other RS values at which Raman scattering is associated with the cancerous state of bladder tissues occur at about 1000, 1100, 1250, 1370 and 2900 cm⁻¹.

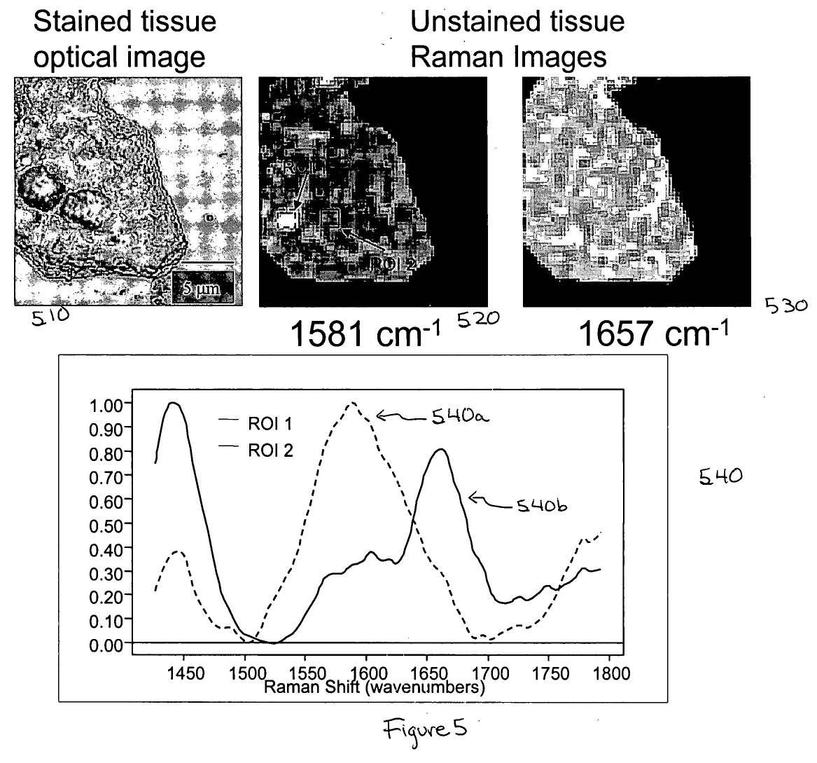

In another embodiment, the system described in FIG. 1 may be used to differentiate normal from cancerous cells in prostate tissue. FIG. 4 shows images of a tissue sample containing prostate cancer. The image 410 shows the standard microscopy image of the stained tissue. The cancerous epithelial cells are in the lower half of the field of image 410. The normal stroma is in the upper part of the field of view of image 410. The image 420 is a Raman image obtained at a Raman shift value of 2870 cm⁻¹ and image 430 is a Raman image obtained at a Raman shift value of 3080 cm⁻¹. This data was taken with a tunable filter. The data has been modified into a format which is a model for the data acquired with a Raman CTIS system. The Raman image frame is 64×64 pixels with 36 frames in spectral space spanning a spectral region 2800 to 3150 cm⁻¹. Spectrum 440 illustrates the Raman spectra obtained the epithelial cells 440a and the normal stroma 440b. In this preferred embodiment we show that the spatial and spectral resolution achievable with a Raman CTIS system is appropriate for tissue sample imaging of relevant spectroscopic information. Also we show in this example that the spectral region from 2800 to 3150 cm⁻¹ carries enough information to differentiate tissue types (cancerous epithelium vs. normal stroma). This approach is also applicable to other tissue types including but not limited to breast, bladder, colon, brain, kidney, skin as discussed in the patents and patent applications described herein.

In yet another embodiment, the system described in FIG. 1 may be used to differentiate subcellular distribution of Raman signatures which arise from the native molecules within the cell. FIG. 5 shows images 510, 520, 530 of an epithelial cell from the urine of a patient with Grade 3 bladder cancer. Image 510 is a standard microscopy image of the unstained cell. Image 520 is a Raman image at 1581 cm⁻¹ and image 530 is a Raman image at 1657 cm⁻¹ indicating the contrast present in a Raman image of unstained samples. This data was taken with a tunable filter. The data has been modified into a format which is a model for the data acquired with a Raman CTIS system. The Raman image frame is 64×64 pixels with 39 frames in spectral space spanning a spectral region 1426 to 1796 cm⁻¹. In this preferred embodiment we show that the spatial and spectral resolution achievable with a Raman CTIS system is appropriate for subcellular imaging of relevant spectroscopic information. Also demonstrated here is that restricted sub regions of the so called “Fingerprint spectral region” can be used to obtain clinically significant contrast in cellular samples from people. This is not restricted to cells from bladder, but can be extended to cells from other organs including, but not limited to: breast, cervix, skin, colon, kidney, prostate bronchus and lung. A key part of extending to other organs is determining the subspectral region of interest. It is anticipated that for different organs and different disease states, different subspectral regions will have the most relevant contrast.

The present invention may be embodied in other specific forms without departing from the spirit or essential attributes of the invention. Accordingly, reference should be made to the appended claims, rather than the foregoing specification, as indicated the scope of the invention. Although the foregoing description is directed to the preferred embodiments of the invention, it is noted that other variations and modification will be apparent to those skilled in the art, and may be made without departing from the spirit or scope of the invention.

What is claimed:

1. A method for measuring spatial and spectral information from a sample using computed tomography imaging spectroscopy, comprising the steps of:
(a) illuminating an area of the sample using an illumination source having substantially monochromatic light;
(b) directing Raman scattered light from said illuminated area of said sample onto a two dimensional grating disperser;
(c) directing light output from the two dimensional grating disperser onto a detector that detects a dispersed image; and
(d) applying the dispersed image from the detector to a processing algorithm that generates a plurality of spatially accurate, wavelength resolved images of the sample.

2. The method of claim 1, wherein said two dimensional grating disperser comprises a disperser having a spectral resolution of less than or equal to 0.25 nm.

3. The method of claim 1, wherein said light output from the two dimensional grating disperser comprises a Raman Shift value in a spectra range of 2800 cm⁻¹, to 3200 cm⁻¹.

4. The method of claim 1, wherein one or more of the spatially accurate, wavelength resolved images have a spectral resolution of less than or equal to 20 cm⁻¹.

5. The method of claim 1, wherein said light output from the two dimensional grating disperser comprises a Raman Shift value in a spectra range of 500 cm⁻¹ to 2000 cm⁻¹.

6. The method of claim 1, wherein said detector comprises a focal plane array detector.

7. The method of claim 6, wherein the focal plane array detector is comprised of an array having 1000×1000 pixels to 4000×4000 pixels.

8. The method of claim 1, wherein said algorithm comprises a tomographic reconstruction algorithm.

9. The method of claim 1, where in said monochromatic light has a wavelength of about 532 nm.

10. The method of claim 1, wherein steps (a)-(d) are performed at a first time in order to generate a first plurality of spatially accurate, wavelength resolved images representative of the sample at the first time, said method further comprising:
performing steps (a)-(d) again at a second time in order to generate a second plurality of spatially accurate, wavelength resolved images representative of the sample at the second time, the second time being later than the first time; and
detecting one or more dynamic changes in the sample between the first and second times by comparing the first plurality of spatially accurate, wavelength resolved images and the second plurality of spatially accurate, wavelength resolved images.
